(19) United States
(12) Patent Application Publication
(10) Pub. No.: US 2009/0065645 A1
(43) Pub. Date: Mar. 12, 2009

(54) Articles with reduced fluid dynamic drag

(75) Inventor: Colin L. Cini, Vernon, CT (US)

Correspondence Address: Kenneth C. Baran, 400 Main Street, Mail Stop 132-13, East Hartford, CT, 06108, US

(73) Assignee: United Technologies Corporation

(21) Appl. No.: 11/702,369

(22) Filed: Feb. 5, 2007

(51) Int. Cl. B64C 1/38

(52) U.S. Cl. 244/130

(57) ABSTRACT

A fluid dynamic article includes a treated surface 32 and a transversely opposite surface 34. The treated surface 32 is substantially completely populated by a series of boundary layer flow guides 36 comprising longitudinally extending, laterally distributed, alternating troughs 40 and ridges 42. The depth d and height h of the troughs and ridges are substantially constant in a longitudinal direction. The opposite surface 34 has a configuration independent of the treated surface 32. The article may take the form of a nacelle 16 or 20 for an aircraft turbine engine.

### TECHNICAL FIELD

This application describes articles, such as turbine engine nacelles, having reduced fluid dynamic drag, and in particular articles having boundary layer flow guides for effecting drag reduction.

### BACKGROUND

It is well known to minimize the effects of fluid dynamic drag exhibited by objects intended to move relative to a liquid or gas. One source of drag is friction between the object and a turbulent boundary layer adjacent to the surface thereof. Friction, and therefore drag, may be reduced by ensuring a laminar boundary layer. Although many techniques for maintaining or inducing a laminar boundary layer are known, not all techniques are suitable for all applications. It is, therefore, desirable to extend the state of the art by providing new ways for ensuring boundary layer laminarity.

### SUMMARY

A fluid dynamic article includes a treated surface and a transversely opposite surface. The treated surface is substantially completely populated by a series of boundary layer flow guides comprising longitudinally extending, laterally distributed, alternating troughs and ridges. The depth and height of the troughs and ridges are substantially constant in a longitudinal direction. The transversely opposite surface has a configuration independent of the treated surface.

The foregoing and other features of the various embodiments of the fluid dynamic article described herein will become more apparent from the following detailed description and the accompanying drawings.

### BRIEF DESCRIPTION OF THE DRAWINGS

FIG. 1 is a partial cross sectional side elevation view of a turbofan gas turbine engine and associated fan and core nacelles.

FIG. 2 is a view in the direction 2-2 of FIG. 1.

FIG. 3 is a view in the direction 3-3 of FIG. 1 showing a fairing that obstructs fluid flow.

FIG. 4 is a view in the direction 4-4 of FIG. 1 showing undulant boundary layer flow guides on the fan nacelle.

FIG. 4A is a perspective view of the flow guides shown in FIG. 4.

FIG. 5 is a developed view of the region 5 of FIG. 3 schematically showing an irregular pitch of the flow guides in the vicinity of an obstruction and a regular pitch remote from the obstruction.

FIG. 6 is a developed view similar to FIG. 5 showing a reduced quantity of flow guides in the vicinity of the obstruction.

FIG. 7 is a view similar to FIG. 4 showing flow guides having a crenellated profile.

FIG. 7A is a perspective view of the flow guides shown in FIG. 7.

FIG. 8 is a view similar to FIG. 7 showing flow guides having a sawtooth profile.

FIG. 8A is a perspective view of the flow guides shown in FIG. 8.

FIG. 9 is a view similar to FIGS. 4, 7 and 8 showing an alternate construction of the flow guides.

FIG. 10 is a view similar to FIG. 4 showing a variant of the guides applied to a nacelle.

### DETAILED DESCRIPTION

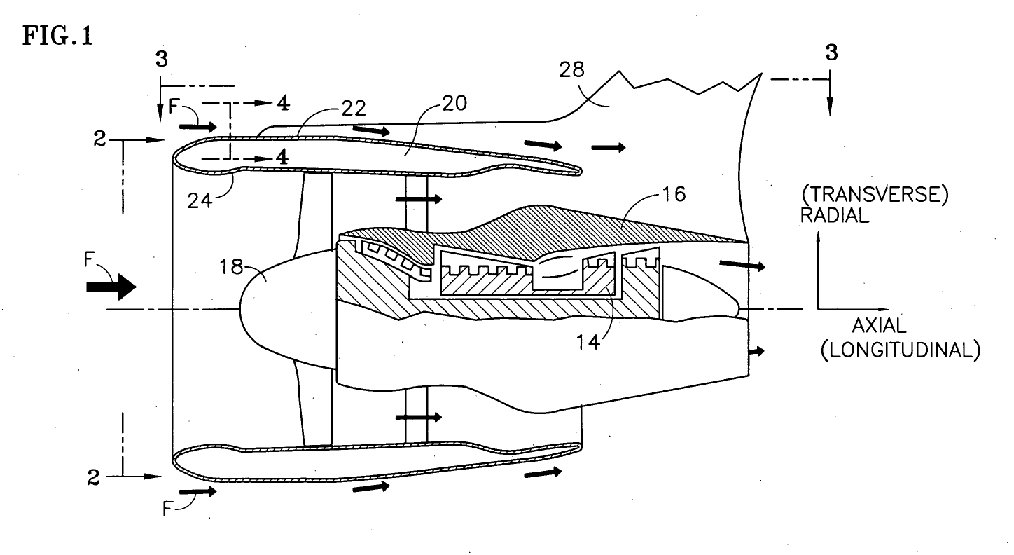

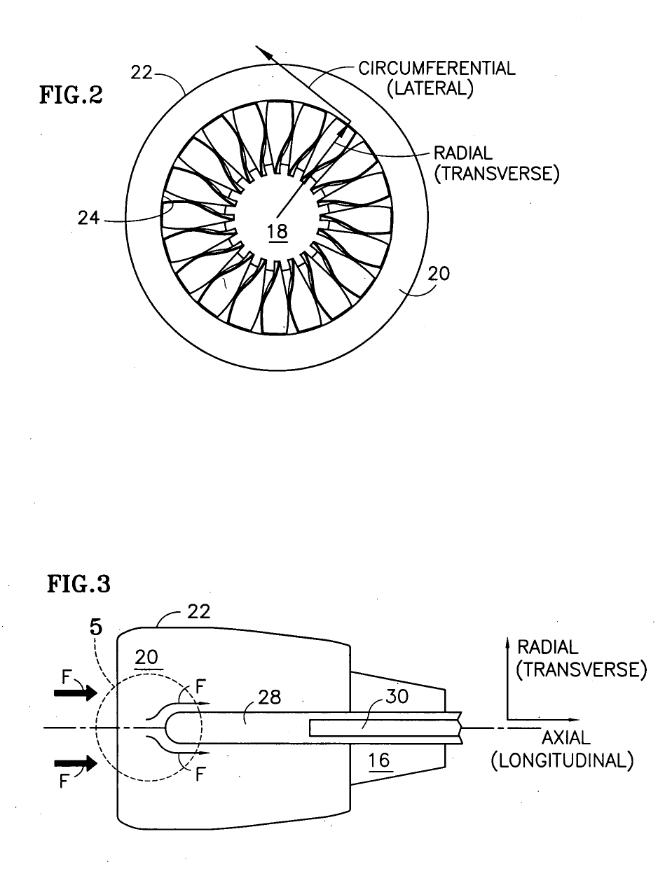

FIGS. 1-3 show an aircraft turbofan engine comprising an engine core 14 circumscribed by a core nacelle 16, and a fan 18 circumscribed by a fan nacelle 20. The fan and core nacelles are aerodynamically streamlined features. As seen in FIG. 2, a typical nacelle, such as the fan nacelle, has a circular or nearly circular cross sectional geometry with aerodynamically streamlined external and internal portions 22, 24. An aerodynamically streamlined fairing 28 enshrouds a local strut 30 that connects the engine to its host aircraft. FIGS. 1-3 also show axial, circumferential and radial coordinate axes useful for making directional references. The axial, circumferential and radial axes may be equivalently thought of as longitudinal, lateral and transverse axes respectively. Movement of the engine and host aircraft through the atmosphere is typically represented by a stream of fluid F, specifically ambient air, flowing into the engine and over the nacelles. As seen in FIG. 3, the fairing 28 is a local obstruction in the fluid stream.

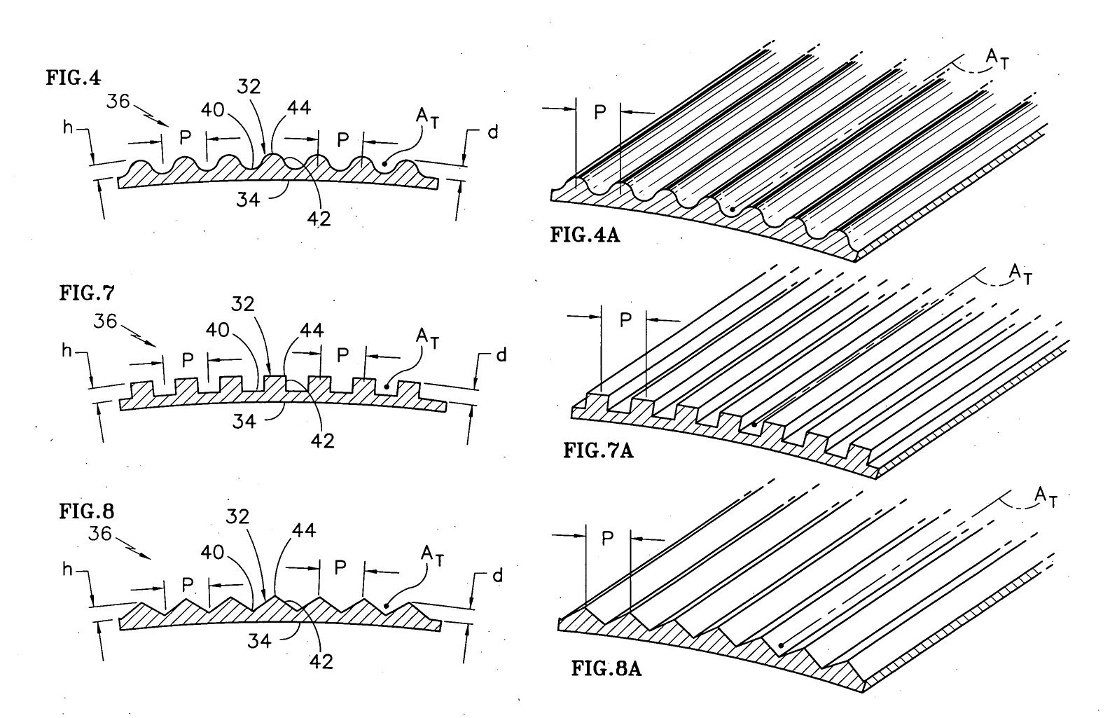

Referring to FIGS. 4 and 4A, radially external portion 22 of the nacelle has a treated surface 32 exposed to the stream of fluid F and a transversely opposite surface 34. A series of boundary layer flow guides 36 populates substantially the entirety of the exposed surface. The flow guides comprise longitudinally extending, laterally distributed troughs 40 and ridges 42, each ridge having a peak 44. A typical trough may be thought of as having a longitudinally extending axis A_{T}. As used in this specification (including the accompanying claims) to describe the orientation of the troughs, the longitudinal direction is a direction generally aligned with the flow direction of the free stream fluid. The lateral direction is therefore a direction substantially perpendicular to the streamwise direction.

Each trough has a depth d. Each ridge has a height h equal to the depth d. The depth and height of a given trough or ridge is substantially constant in the axial (longitudinal) direction. The transversely opposite surface 34 is not exposed to the fluid stream and therefore is devoid of flow guides 36. The configuration of the opposite surface 34 is therefore independent of the configuration of the treated surface. The depth d and height h are typically in a range of about 10% to about 50% of the anticipated local thickness of the fluid boundary layer adjacent the surface.

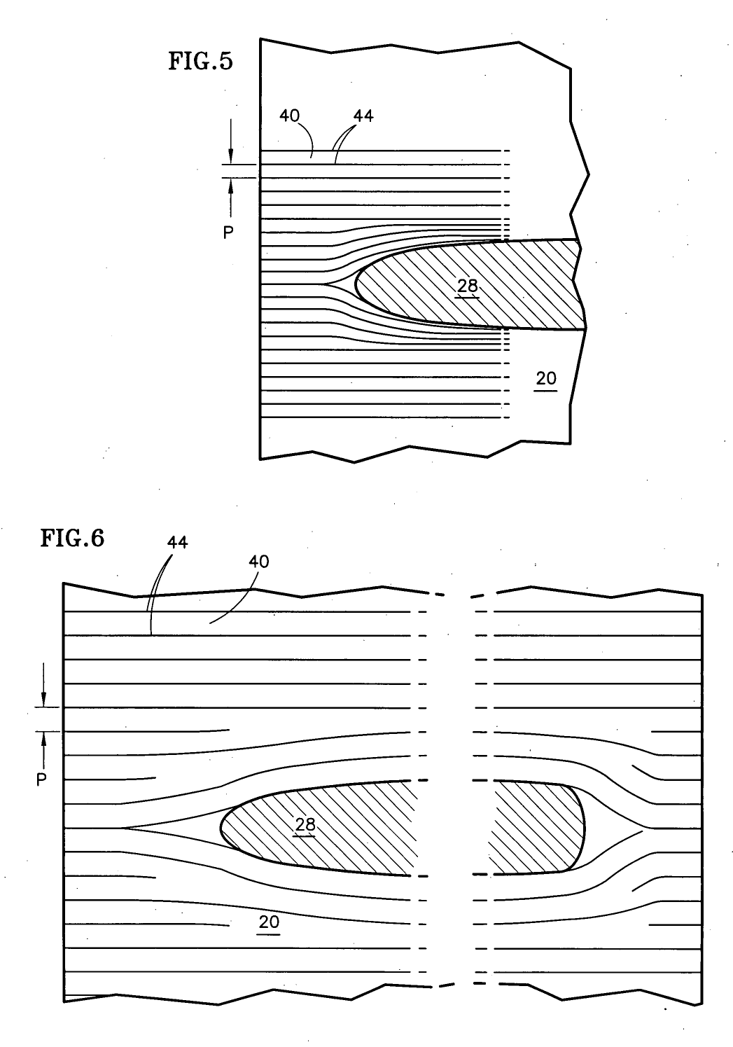

Referring to FIGS. 4, 4A and 5 the lateral (circumferential) distance between adjacent troughs or adjacent ridges is referred to as pitch P. Over at least part of the longitudinal extent of the surface, the pitch is regular, i.e. constant (FIGS. 4, 4A and the left portion of FIG. 5) and is in a range of between about 10% to about 50% of the anticipated local thickness of the fluid boundary layer. However in some regions, for example in the vicinity of an obstruction such as the fairing 28 of FIG. 5, the local pitch may necessarily differ from the pitch at places more remote from the obstruction. In FIG. 5, the locally differing pitch is a constant pitch, different from the constant pitch elsewhere. However the locally differing pitch may itself be a varying pitch, for example a pitch that progressively increases from a small value in the immediate vicinity of the obstruction to a larger value at locations more remote from the obstruction. Alternatively, or in addition, the quantity of troughs and ridges may be different at different axial locations as depicted in FIG. 6 in order, for example, to accommodate the presence of an obstruction.

The flow guides, as seen in FIGS. 4 and 4A have an undulant cross sectional geometry, such as a sine wave. Other example geometries include a square, rectangular or other crenellated profile as seen in FIGS. 7 and 7A, or a sawtooth profile as seen in FIGS. 8 and 8A.

During operation, the flow guides facilitate boundary layer laminarity by guiding the boundary layer portion of the fluid stream over the surface, particularly in the vicinity of local obstructions.

The troughs and ridges may be formed in a number of ways. For example, one way is to selectively remove material from a virgin (unfinished) surface. The material removal may be accomplished by any suitable method such as mechanical machining, electrical machining and chemical removal. Another possible way is to mask the regions of the unfinished surface corresponding to the troughs and then apply a coating to the unmasked regions so that the coating, after having cured, will form the ridges. For articles that are made by casting, the flow guides may be cast into the surface.

Yet another way to form the flow guides is to apply a sheet of film to the unfinished surface. One type of film that may be suitable is an aliphatic grade polyurethane film manufactured by Argotec, Inc. of Greenfield, Mass., United States. Such a film may be preformed to include the flow guides. Alternatively, the flow guides may be formed in-situ in a “flat” film previously applied to the unfinished surface of interest.

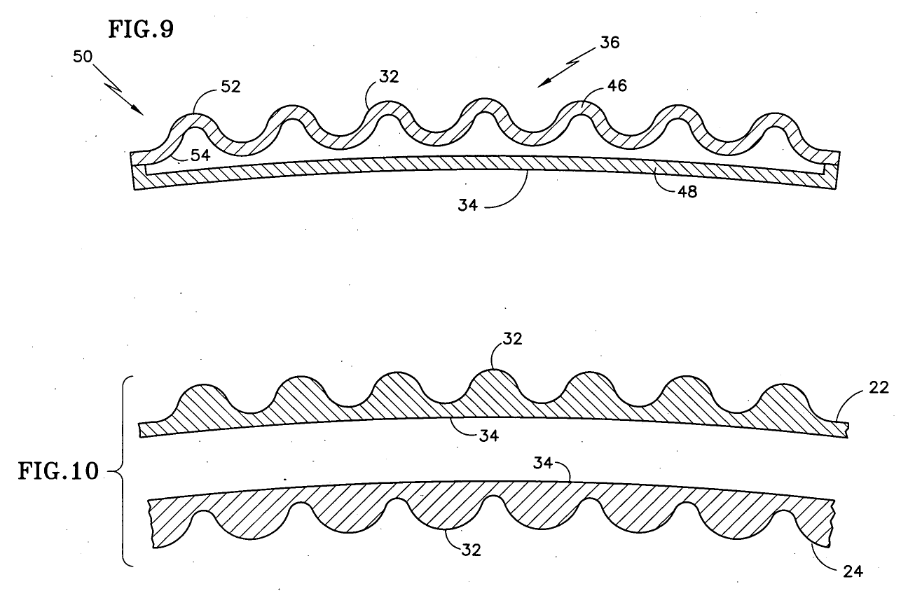

As seen in FIG. 9, yet another way to form the flow guides is to mechanically form a face sheet 46 to define the flow guides 36 and then attach the face sheet to a companion structure 48 that constitutes the opposite surface 34 of the fluid dynamic article 50.

Whatever method is used, the transversely opposite surface has a surface configuration that is independent of the configuration of the treated surface. That is, the formation of the flow guide features in the treated surface does not result in a corresponding formation of features on the transversely opposite surface. This is clearly evident in FIGS. 4, 4A, 7, 7A, 8 and 8A where surfaces 32 are treated and opposite surfaces 34 are untreated and independent. The independence is also seen in FIG. 9 where, even though the two surfaces 52, 54 of the face sheet were both affected by the formation of the guides 36, the finish-assembled fluid dynamic article has an opposite surface 34 whose physical configuration is independent of the treated surface 32 corresponding to the face sheet. FIG. 10 shows yet another variant in which both the external and internal portions, 22, 24 of the fan nacelle have treated surfaces 32. The configuration of the opposite surface 34 of each portion (22 or 24) is independent of the configuration of the treated surface 32 of the same portion because the formation of the flow guides on the treated surface does not affect the configuration of the other, opposite surface 34.

The fluid dynamic article has been described in the context of a nacelle for a gas turbine engine moving through air. A nacelle, however, is but one of many forms that the article might take.

Although this disclosure refers to specific embodiments, it will be understood by those skilled in the art that various changes in form and detail may be made without departing from the subject matter set forth in the accompanying claims.

I claim:

1. A fluid dynamic article having a treated surface and a transversely opposite surface, the treated surface being substantially completely populated by a series of boundary layer flow guides comprising longitudinally extending, laterally distributed, alternating troughs and ridges, the troughs and ridges having a depth and height respectively that are each substantially constant in a longitudinal direction, the opposite surface having a configuration independent of the treated surface.

2. The article of claim 1 wherein the troughs and ridges exhibit a regular pitch in a lateral direction.

3. The article of claim 1 wherein the troughs and ridges exhibit a varying pitch in a lateral direction.

4. The article of claim 3 wherein the varying pitch occurs in the vicinity of an obstruction to free stream fluid flow.

5. The article of claim 1 wherein the depth and height are in a range of about 10% to about 50% of an anticipated local boundary layer thickness.

6. The article of claim 1 wherein a pitch of the troughs and ridges are in a range of about 10% to about 50% of an anticipated local boundary layer thickness.

7. The article of claim 1 wherein the troughs and ridges have a cross sectional geometry selected from the group consisting of undulant, crenellated and sawtooth.

8. The article of claim 1 wherein the troughs and ridges result from material removal from an unfinished surface.

9. The article of claim 8 wherein the material removal is accomplished by a process selected from the group consisting of mechanical machining, electrical machining, and chemical removal.

10. The article of claim 1 wherein the troughs and ridges are cast during casting of the article.

11. The article of claim 1 wherein the troughs and ridges result from application of a film to an unfinished surface.

12. The article of claim 11 wherein the film is preformed with the troughs and ridges.

13. The article of claim 11 wherein the troughs and ridges are formed in-situ subsequent to application of the film to the unfinished surface.

14. The article of claim 11 wherein the troughs and ridges result from application of a coating to an unfinished surface.

15. The article of claim 1 in the form of a turbine engine nacelle.
